(19) United States
(12) Patent Application Publication
(10) Pub. No.: US 2012/0005240 A1
(43) Pub. Date: Jan. 5, 2012

(54) EVENT DATABASE, DATA MANAGEMENT DEVICE, DATA MANAGEMENT SYSTEM, DATA MANAGEMENT PROGRAM, AND DATA MANAGEMENT METHOD

(75) Inventor: Satoshi Kinoshita, Minato-ku (JP)

(73) Assignee: NEC CORPORATION, Minato-ku, Tokyo (JP)

(21) Appl. No.: 13/257,236

(22) PCT Filed: Mar. 15, 2010
(86) PCT No.: PCT/JP2010/054754

§ 371 Date: Sep. 16, 2011

(30) Foreign Application Priority Data
Mar. 17, 2009 (JP) 2009-063722

(51) Int. Cl. G06F 17/30

(52) U.S. Cl. 707/802; 707/E17.005

(57) ABSTRACT

Provided is a device capable of effectively retrieving a product, etc., under a predetermined condition (for example, in stock), from a database in which event data relating to products, etc., is accumulated. A data management device is provided with an event storage means which stores event data including the occurrence time of an event which changes the state of a target from a specific state to another state or from the another state to the specific state, the type of event, and a target ID which is an identifier of the target the state of which has been changed by the event; and a CKPT creation unit which retrieves the earliest time at a predetermined creation time (the time that the target which was changed to the specific state earliest was changed to the specific state, among the targets which are judged to have been in the specific state at that time, on the basis of the event data) from the event data in the event storage means, creates a check point containing the creation time and the earliest time, and stores the check point in a CKPT storage means.

### TECHNICAL FIELD

The present invention relates to an event database, a data management device, a data management system, a data management program, and a data management method.

### BACKGROUND ART

Event data is data associating an event with the occurrence time of the event. The event data includes the occurrence time of the event, a type, an identifier of a target (goods or the like) of the event, a place of occurrence, a reason of occurrence, and the like. In a logistics management application or the like, the event data is acquired by using an RFID (Radio Frequency IDentification), a sensor, a terminal, and the like, accumulated in a database, and used for reference or analysis of distribution information on the goods or the like.

A gate device which reads an ID tag included in medical supplies and transmits the identifier of the medical supplies and the event data in which a read date and time, a place, and information on the medical supplies are associated with each other to a server is disclosed in patent document 1. The server receives the event data from the gate device installed in a manufacturer, a sales company, a hospital, and the like and creates trace information. The server calculates a quantity of medical supplies for each location at which the medical supplies are detected from the trace information and generates stock data with which the quantity of medical supplies is associated in a predetermined location.

An invention in which the identifier of the RFID tag attached to a logistics object passing through a distribution point is read by a reader/writer and information on identifier/time of passage/point of passage is stored as one distribution event record is disclosed in patent document 2. The server receives the distribution event record from each distribution point and stores it in a distribution history database. When the server receives an inquiry in which the identifier and the period are specified, it transmits history information indicating the distribution point through which the logistics object with the identifier had passed in the period as a reply.

A parcel delivery management server which receives work completion information from a mobile terminal, generates a time stamp indicating the reception time and keeps a log is disclosed in patent document 3.

### PRIOR ART DOCUMENT

### Patent Document

[Patent document 1] Japanese Patent Application Laid-Open No. 2005-335926
[Patent document 2] Japanese Patent Application Laid-Open No. 2005-234628
[Patent document 3] Japanese Patent Application Laid-Open No. 2003-128252

### DISCLOSURE OF THE INVENTION

### Problems to be Solved by the Invention

The data management device cannot efficiently retrieve goods or the like that are in a specific state (for example, in a stock state) from the database in which the event data of the goods or the like is accumulated. The server of the patent document 1 does not disclose a technology with which trace information can be efficiently retrieved when generating the stock data of the medical supplies. The technology of patent documents 2 and 3 does not retrieve the logistics object or the like that is in the specific state from the history database. Accordingly, the technology described in the cited documents 1, 2 and 3 does not solve the above-mentioned problem.

An object of the present invention is to provide an event database for solving the above-mentioned problem, a data management device, a data management system, a data management program, and a data management method.

### Means for Solving the Problems

A data management device according to one exemplary embodiment of the present invention includes event storage means for storing one or more event data each of which includes an occurrence time of an event which changes a state of a target from a specific state to another state or from another state to the specific state according to a type, the type of the event, and a target ID that is an identifier of the target, the state of which has been changed by the event; and CKPT creation means for retrieving an earliest time at a predetermined creation time from the event data in the event storage means, wherein the earliest time is a time when a target, which was changed to the specific state earliest among targets judged from the event data to be in the specific state at the creation time, was changed to the specific state, creating a check point including the creation time and the earliest time, and storing the check point in CKPT storage means.

An event database according to one exemplary embodiment of the present invention includes event storage means for storing one or more event data each of which includes an occurrence time of an event which changes a state of a target from a specific state to another state or from another state to the specific state according to a type, the type of the event, and a target ID that is an identifier of the target, the state of which has been changed by the event, and CKPT storage means for storing a check point including an earliest time at a predetermined creation time that is retrieved from the event data in the event storage means wherein, the earliest time is a time when a target, which was changed to the specific state earliest among targets judged from the event data to be in the specific state at the creation time, was changed to the specific state and the creation time.

A data management program according to one exemplary embodiment of the present invention causes a computer to perform an event registration process in which one or more event data each of which includes an occurrence time of an event which changes a state of a target from a specific state to another state or from another state to the specific state according to a type, the type of the event, and a target ID that is an identifier of the target, a state of which has been changed by the event, are stored in event storing means, and a CKPT creation process in which an earliest time at a predetermined creation time is retrieved from the event data in the event storage means wherein, the earliest time is a time when a target, which was changed to the specific state earliest among targets judged from the event data to be in the specific state at the creation time, was changed to the specific state, a check point including the creation time and the earliest time is created, and the check point is stored in CKPT storage means.

A data management method according to one exemplary embodiment of the present invention includes storing one or more event data each of which includes an occurrence time of an event which changes a state of a target from a specific state to another state or from another state to the specific state according to a type, the type of the event, and a target ID that is an identifier of the target, the state of which has been changed by the event, in event storing means, and retrieving an earliest time at a predetermined creation time from the event data in the event storage means, wherein the earliest time is a time when the state of the target changed to the specific state earliest among targets judged from the event data to be in the specific state at the creation time, was changed to the specific state, creating a check point including the creation time and the earliest time, and storing the check point in CKPT storage means.

### Advantage of the Invention

The data management device can efficiently retrieve goods or the like that are in a specific state from a database in which event data of the goods or the like is accumulated.

### BRIEF DESCRIPTION OF THE DRAWINGS

FIG. 1 is an entire configuration diagram of a data management system 10 according to a first exemplary embodiment.

FIG. 2 is a figure showing a structure of data stored in an event storage unit 26.

FIG. 3 is a figure showing a structure of data stored in a change storage unit 27.

FIG. 4 is a figure showing a structure of data stored in a CKPT storage unit 28.

FIG. 5 is a figure showing a structure of data of an array 60.

FIG. 6A is an operation flowchart (1/2) of a CKPT creation unit 24.

FIG. 6B is an operation flowchart (2/2) of a CKPT creation unit 24.

FIG. 7A is an operation flowchart (1/2) of a retrieval unit 25.

FIG. 7B is an operation flowchart (2/2) of a retrieval unit 25.

FIG. 8 is an entire configuration diagram of a data management system 10 according to the second exemplary embodiment.

FIG. 9 is an operation flowchart of a CKPT creation unit 24 of the second exemplary embodiment.

FIG. 10 is an operation flowchart of a retrieval unit 25 of the second exemplary embodiment.

FIG. 11 is a diagram showing a configuration of a data management device 20 of the fourth exemplary embodiment.

FIG. 12 is a block diagram of an event database 70.

### DESCRIPTION OF SYMBOL

10 data management system
11 event terminal
12 RFID reader
13 user terminal
14 network
20 data management device
21 computer
22 event registration unit
23 input/output unit
24 CKPT creation unit
25 retrieval unit
26 event storage unit
27 change storage unit
28 CKPT storage unit
29 data management program
2A long-term event storage unit
2B long-term CKPT storage unit
30 event data
31 occurrence time
32 target ID
33 type
40 transition table
41 range of application
42 original state
43 new state
44 specified list
50 check point
51 creation time
52 specific state
53 the earliest time
60 array
61 array element
62 current state
63 transition time
70 event database

### MOST PREFERRED MODE FOR CARRYING OUT THE INVENTION

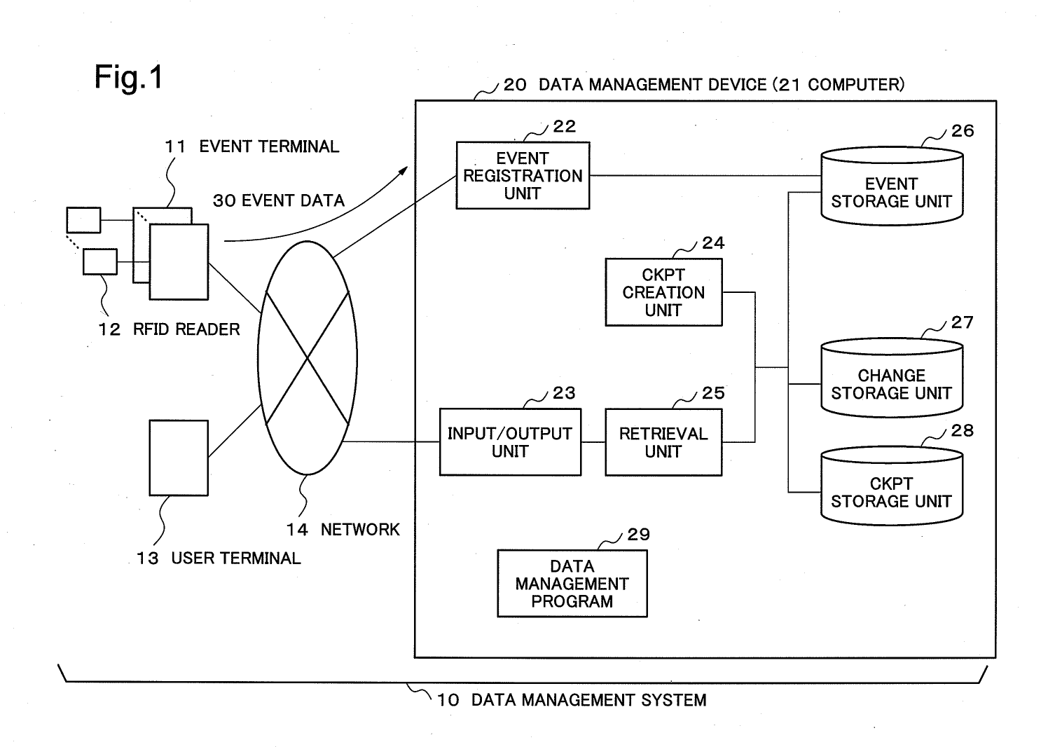

FIG. 1 is an entire configuration diagram of a data management system 10 according to a first exemplary embodiment of the present invention. The data management system 10 is composed of for example, a data management device 20, an event terminal 11, and a user terminal 13. The event terminal 11 and the user terminal 13 are connected to the data management device 20 via a network 14.

The data management device 20 includes an event registration unit 22, an input/output unit 23, a CKPT creation unit 24, a retrieval unit 25, an event storage unit 26, a change storage unit 27, and a CKPT storage unit 28. Here, “CKPT” represents a check point (ChecKPoinT).

The event registration unit 22 inputs event data 30 from for example, the event terminal 11 and stores it in the event storage unit 26. The retrieval unit 25 retrieves the event data 30 of the event storage unit 26 and outputs a list of the targets (goods or the like) of the event that are in the specific state. For example, the input/output unit 23 receives a retrieval request from the user terminal 13 and transmits a result of the retrieval as a reply.

The CKPT creation unit 24 creates a check point 50 and stores it in the CKPT storage unit 28. The check point 50 is data for increasing a retrieval speed by narrowing a retrieval range of the event data 30 in the event storage unit 26.

For example, it is assumed that the retrieval unit 25 retrieves goods in stock in a warehouse from the event storage unit 26 which stores the event data 30 on storage and delivery of goods or the like. Generally, it is often the case that the goods or the like that were stored in the warehouse in past times has already been delivered. If the time of the earliest storage event can be obtained at the time of retrieval with respect to the goods or the like that had been stored in the warehouse but has not been delivered from the warehouse, the retrieval unit 25 can narrow a retrieval range to the event data 30 after that time.

Generally, if the time at which a last state transition had occurred before the time of retrieval is obtained for each target of the event and then, the earliest time among the obtained times for all the targets of the event is obtained, the retrieval unit 25 can narrow the retrieval range of the event data 30 to the event data after that time. The data management device 20 stores this earliest time in the check point 50.

The event registration unit 22, the input/output unit 23, the CKPT creation unit 24, and the retrieval unit 25 are realized as hardware. The event registration unit 22, the input/output unit 23, the CKPT creation unit 24, or the retrieval unit 25 may be realized by a data management program 29 executed by a processor (not shown) of the data management device 20 that is a computer 21.

The event storage unit 26, the change storage unit 27, and the CKPT storage unit 28 are storage devices such as disks, memories, or the like. The change storage unit 27 includes information about a state transition of the target (goods or the like) of the event.

When the event terminal 11 detects the occurrence of the event, for example, it generates the event data 30 and transmits it to the data management device 20. The event terminal 11 includes an RFID reader 12, one of various types of sensors, a keyboard, and the like.

For example, when the target (goods or the like) of the event to which an IC tag is attached passes through an entry gate or an exit gate of the warehouse, the event terminal 11 detects the occurrence of the storage event or the delivery event. The event terminal 11 may detect the occurrence of the event from keyboard input. For example, when a warehouse manager inspects a condition of the goods or the like stored in the warehouse and inputs information indicating that there is no problem from the keyboard, an “inspection completed” event may be detected.

The data management device 20 accumulates the received event data 30 in the event storage unit 26, retrieves the accumulated event data 30 and determines the state (in stock, delivered, or the like) of the target (goods or the like) of the event.

The target of the event is not limited to the goods or the like. Whatever has a state and whose state changes when an event occurs may be used for the target of the event. The target of the event may be not only a thing or an animal but also a service or a contract that is abstract.

For example, a service has a service stop state, a service provision state, a partial service provision state, and the like. The state of the service changes from the service stop state to the service provision state when a service start event occurs. The state of the service changes from the service provision state to the partial service provision state when a device failure event occurs. In this case, the event terminal 11 detects the service start event or the like by the input from a communication device connected to a service provision system or the like.

A contract has a non contracted state and a contracted state. The state of the contract changes from the non contracted state to the contracted state when a negotiation settlement event occurs. In this case, the event terminal 11 detects the negotiation settlement event by the input from the keyboard or the like.

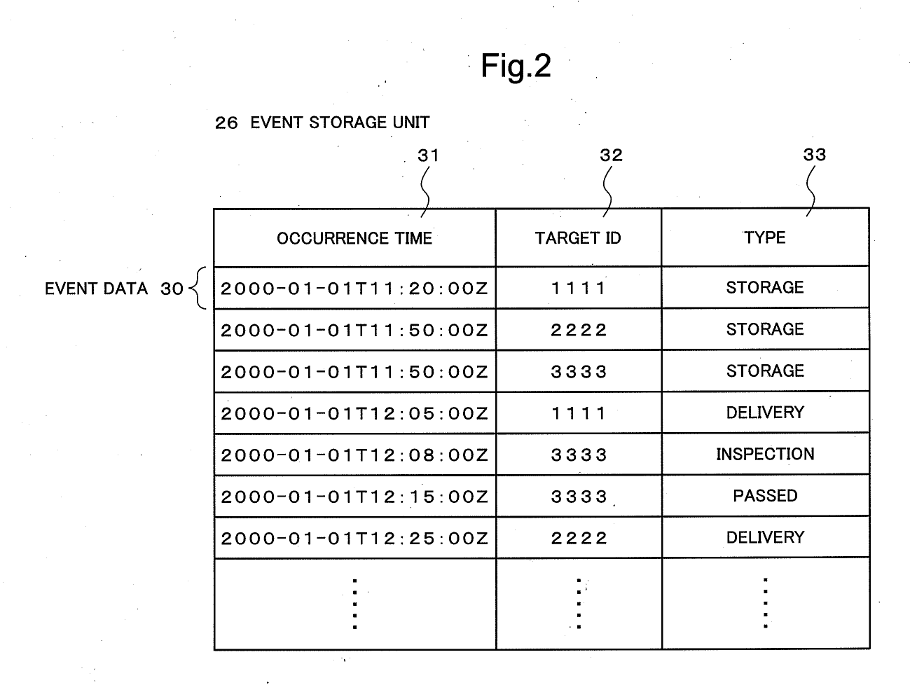

FIG. 2 is a figure showing a structure of data stored in the event storage unit 26. The event storage unit 26 stores one or more event data 30. Each event data 30 includes an occurrence time 31, a target ID 32, and a type 33.

The occurrence time 31 indicates the time at which the event occurs. For example, the occurrence time 31 is a time stamp value provided by the event terminal 11 that detects the occurrence of the event. The occurrence time 31 may be a value provided at the time at which the event registration unit 22 receives the event data 30. For example, the occurrence time 31 includes a value of year, month, day, hours, minutes, and seconds.

The target ID 32 indicates an identifier of the target of the event. For example, the target ID 32 is a value read by the RFID reader 12 of the event terminal 11 from the IC tag attached to the goods or the like that are the targets. The target ID 32 may be a value inputted to the event terminal 11 from the keyboard, the communication device, or the like.

The type 33 represents a type of the event. For example, the type 33 is a type value of the storage event and the delivery event.

The event data 30 is stored so as to be accessed in order of the occurrence time 31. For example, the event data 30 is stored in order of the occurrence time 31. The event data 30 may be stored in dispersed regions which are pointed by a pointer stored in order of the occurrence time 31.

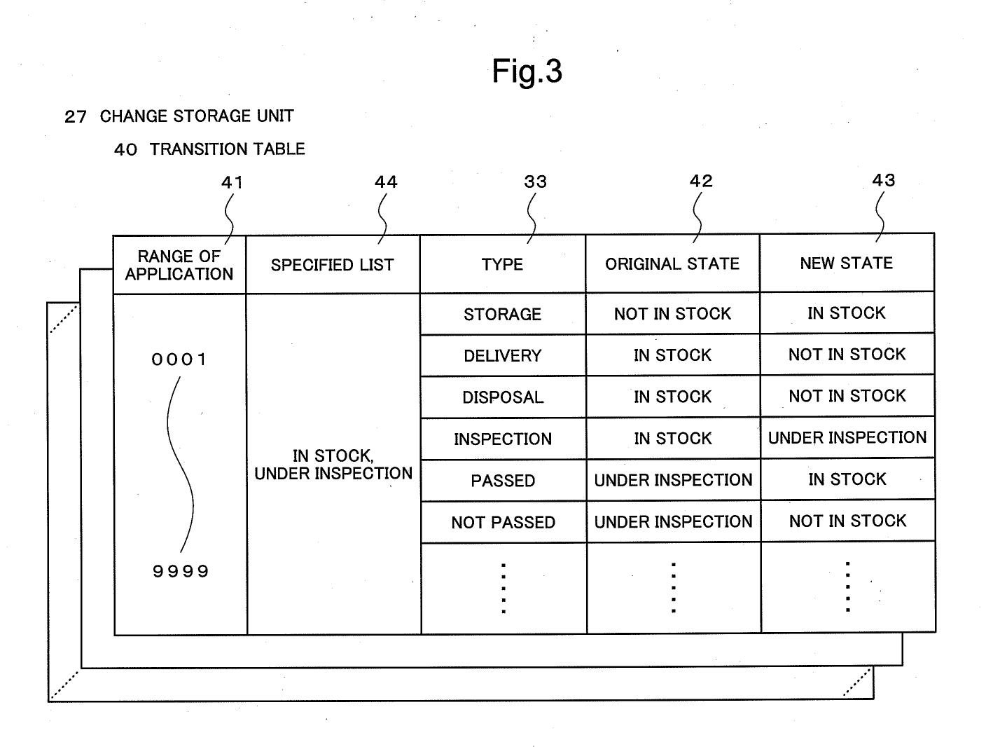

FIG. 3 is a figure showing a structure of data stored in the change storage unit 27. The change storage unit 27 stores one or more transition tables 40. Each transition table 40 is given by an administrator or the like as a system parameter in advance. Each transition table 40 stores a range of application 41, a specified list 44, and, for each of one or more types 33, an original state 42 and a new state 43.

The range of application 41 specifies the target to which the transition table 40 is applied. For example, the range of application 41 stores a range of the value of the target ID 32. When pluralities of types of targets (clothes and perishable food, or the like) exist and each type of targets has a different state and a different type 33 of the occurrence event, the different transition table 40 is applied to each type of targets.

The specified list 44 defines the states (states that can be simultaneously retrieved) that are registered in a check point 50 among the states defined by the transition table 40.

The original state 42 and the new state 43 for each event of the type 33 indicate that when the event of the type 33 occurs, the state of the target is changed from the original state 42 to the new state 43. FIG. 3 shows that for example, when the event data 30 of which the target ID 32 is “0001” and the type 33 is “storage” is inputted, the state of the target (goods or the like) whose target ID 32 is “0001” is changed from “not in stock” to “in stock”.

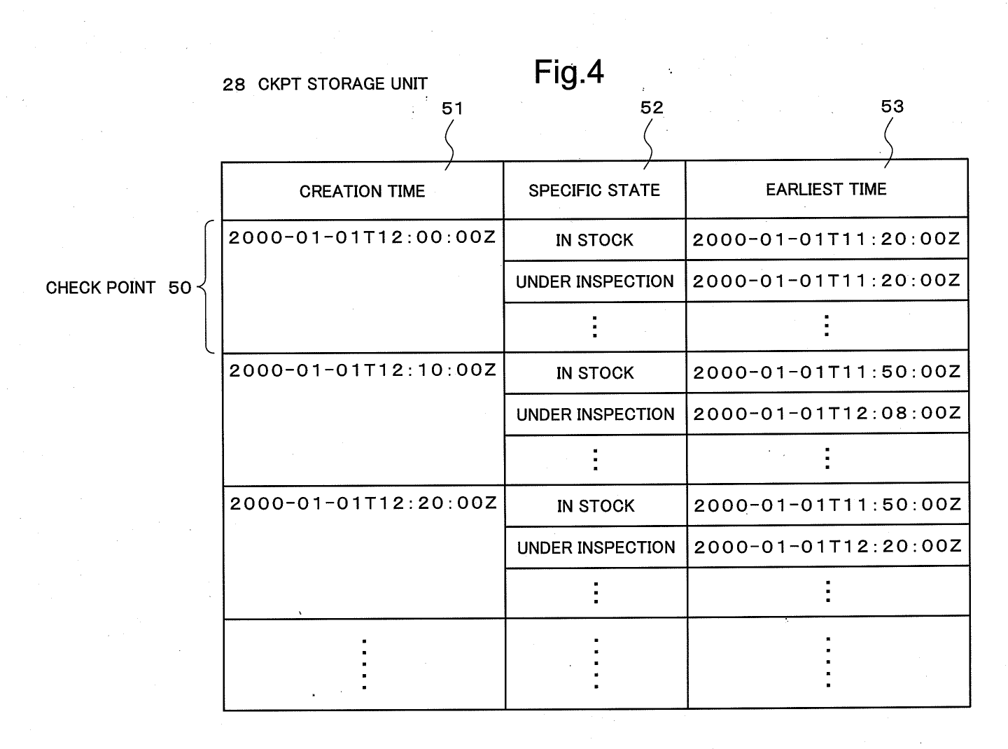

FIG. 4 is a figure showing a structure of data stored in the CKPT storage unit 28. The CKPT storage unit 28 includes one or more check points 50. Each check point 50 includes a creation time 51 and an earliest time 53 for each of one or more specific states 52.

The creation time 51 indicates the time at which the check point 50 is created. The specific state 52 and the earliest time 53 indicate the time when the state of the target changed to the specific state 52 earliest, among the targets judged to be in the specific state 52 based on the event data 30 of the event storage unit 26 or the like at the time of the creation time 51. When there is no target that is in the specific state 52 at the time of the creation time 51, the earliest time 53 has the same value as the creation time 51.

A state recorded in the check point 50 as the specific state 52 is a state stored in the specified list 44 of each transition table 40.

The creation time 51 and the earliest time 53 include a value of, for example, year, month, day, hours, minutes, and seconds. The check point 50 is stored so as to be accessed in order of the creation time 51. For example, the check point 50 is stored in order of the creation time 51. The check point 50 may be stored in dispersed regions which are pointed by a pointer stored in order of the creation time 51.

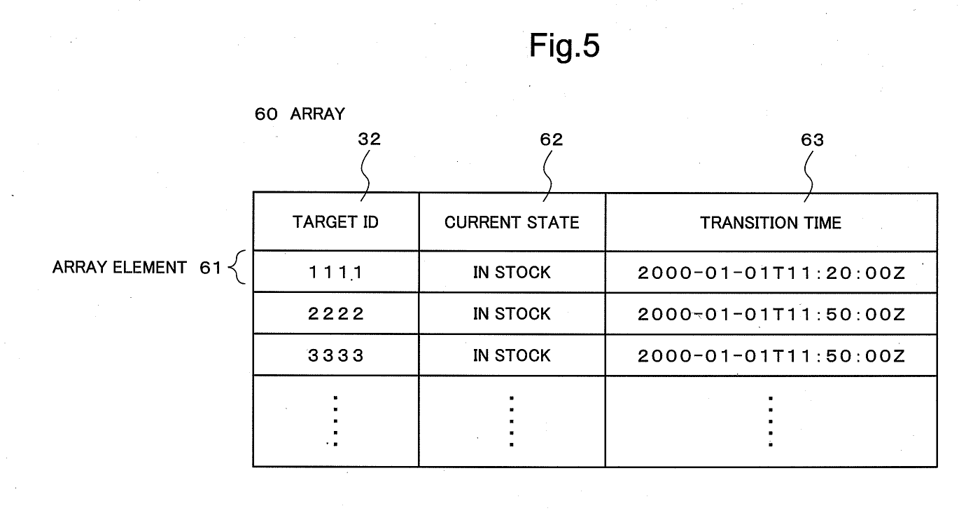

FIG. 5 is a figure showing a structure of data of an array 60. The array 60 is a work area used in an operation process of the CKPT creation unit 24 and the retrieval unit 25 and arranged in a memory (not shown), an association storage device, or the like, of the data management device 20. The array 60 includes a plurality of array elements 61. Each array element 61 includes the target ID 32, a current state 62, and a transition time 63.

The array element 61 shows that the state of the target identified by the target ID 32 changed to the current state 62 at the transition time 63.

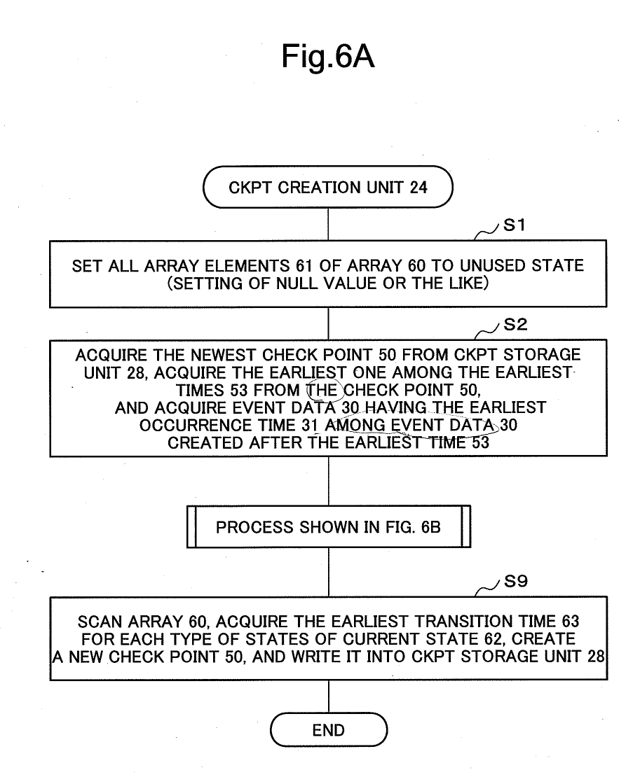

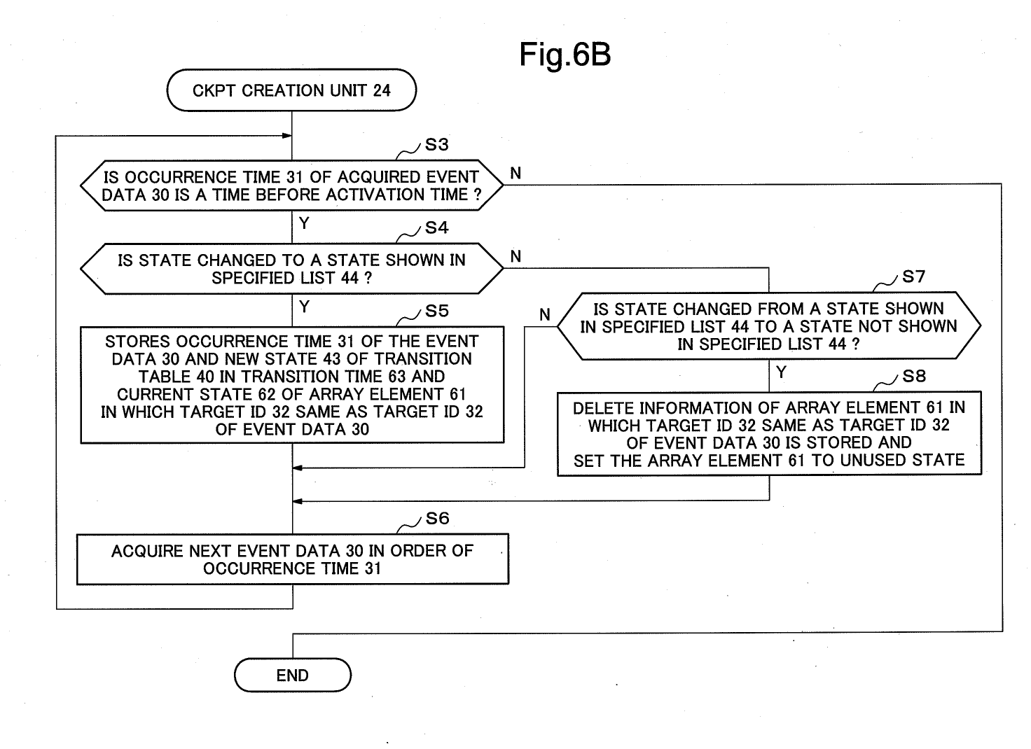

FIG. 6A and FIG. 6B are operation flowcharts of the CKPT creation unit 24. The CKPT creation unit 24 is activated for each activation time that comes on a regular/irregular base. The activation time that comes on an irregular base is the activation time that comes when an operation is performed by the administrator or the predetermined number of the event data 30 is registered. The activation may be performed only once.

When it is activated, the CKPT creation unit 24 sets all the array elements 61 of the array 60 to an unused state (setting of a Null value or the like) (S1).

The CKPT creation unit 24 acquires the newest check point 50 from the CKPT storage unit 28 and acquires the earliest one among the earliest times 53 from the check point 50. The CKPT creation unit 24 acquires the event data 30 having the earliest occurrence time 31 among event data 30 created after the earliest time 53 (S2).

The newest check point 50 is the check point 50 whose creation time 51 is the latest. The event data 30 having the earliest occurrence time 31 is the event data 30 having the occurrence time 31 that is earliest. When a check point 50 is not stored in the CKPT storage unit 28, the CKPT creation unit 24 acquires the first (earliest) event data 30.

When the occurrence time 31 of the acquired event data 30 is a time before the activation time (Y in S3), the CKPT creation unit 24 determines the state transition to be performed based on the event data 30 (S4 and S7), and updates the array 60 described below (S5 and S8). The CKPT creation unit 24 searches the transition table 40 in which the target ID 32 of the event data 30 is included in the range of application 41 by using the type 33 of the event data 30 as a key and determines the state transition (the original state 42 and the new state 43).

When the state is changed to a state shown in the specified list 44 (Y in S4), the CKPT creation unit 24 stores the occurrence time 31 of the event data 30 and the new state 43 of the transition table 40 in the transition time 63 and the current state 62 of the array element 61 in which the target ID 32 that is the same as the target ID 32 of the event data 30 is stored (S5). When the array element 61, in which the target ID 32 that is the same as the target ID 32 of the event data 30 is stored, is not registered in the array 60, the CKPT creation unit 24 acquires the unused array element 61, stores the target ID 32, and stores the above-mentioned transition time 63 and the current state 62.

When the state is changed from a state shown in the specified list 44 to a state not shown in the specified list 44 (N in S4 and Y in S7), the CKPT creation unit 24 deletes information of the array element 61 in which the target ID 32 that is the same as the target ID 32 of the event data 30 is stored, and sets the array element 61 to the unused state (S8). When the array element 61 in which the target ID 32 that is the same as the target ID 32 of the event data 30 is not registered, the CKPT creation unit 24 performs nothing.

When the state transition is not performed or when the state transition is performed between states that are not shown in the specified list 44 (N in S4 and S7), the CKPT creation unit 24 performs nothing.

After the array 60 is updated, the CKPT creation unit 24 acquires the next event data 30 in order of the occurrence time 31 (S6) and the process returns to the process of S3.

When the occurrence time 31 of the acquired event data 30 is later than the activation time (N in S3), the CKPT creation unit 24 scans the array 60, acquires the earliest transition time 63 for each type of the states of the current state 62, creates a new check point 50, and writes it into the CKPT storage unit 28 (S9). The CKPT creation unit 24 stores the activation time, each current state 62, and each earliest transition time 63 in the creation time 51, each specific state 52, and each earliest time 53, respectively. With respect to a state that is defined in the specified list 44 but not registered in the current state 62 of the array 60, the CKPT creation unit 24 stores the activation time in the earliest time 53.

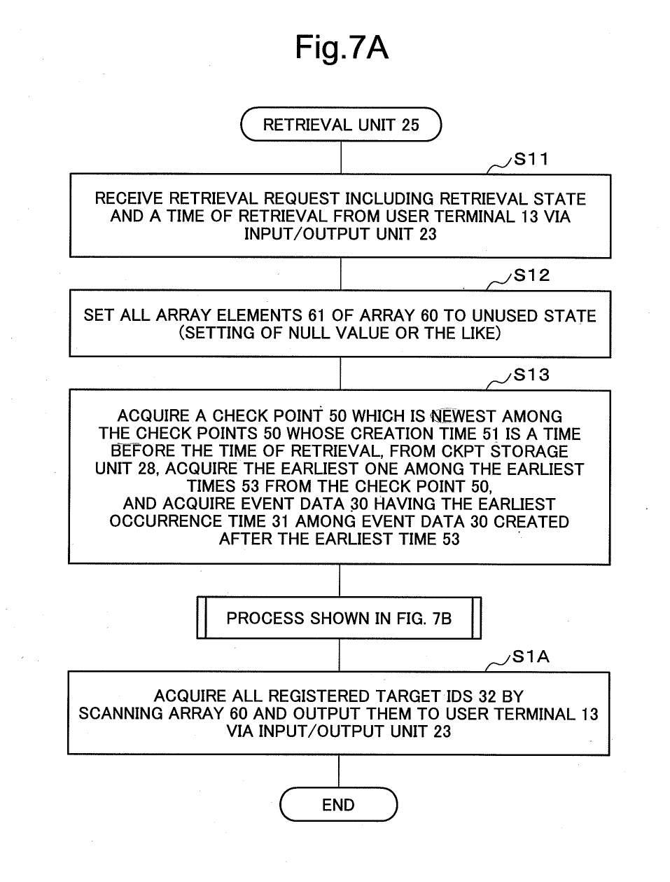

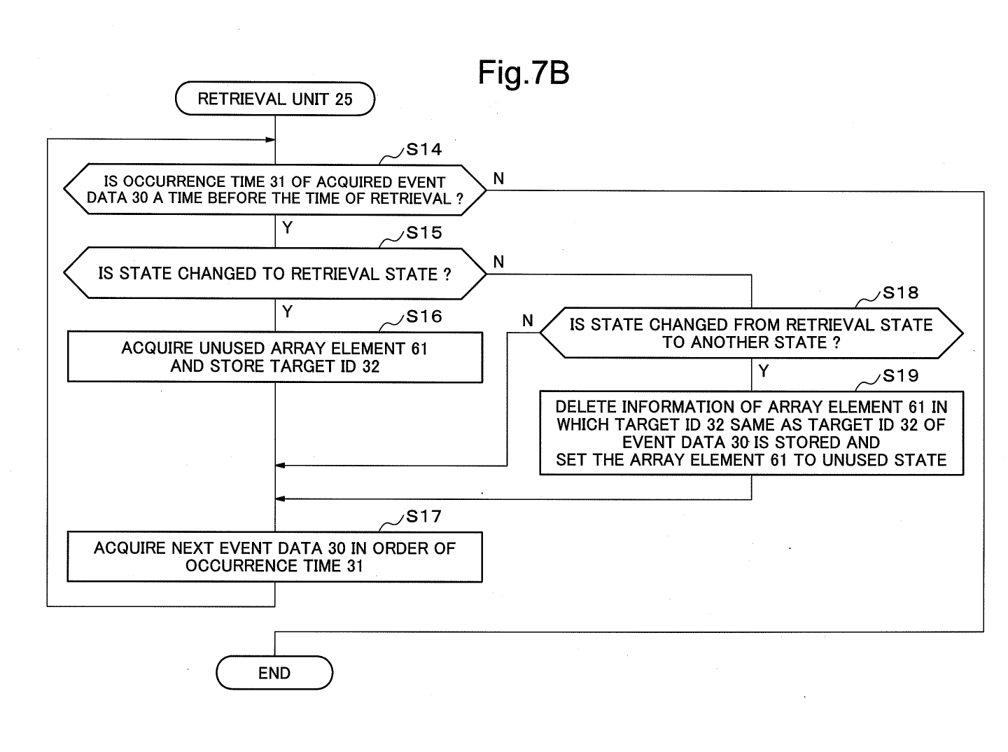

FIG. 7A and FIG. 7B are operation flowcharts of the retrieval unit 25. The retrieval unit 25 receives a retrieval request including a retrieval state and a time of retrieval from the user terminal 13 via the input/output unit 23 (S11). Next, the retrieval unit 25 sets all the array elements 61 of the array 60 to an unused state (setting of a Null value or the like) (S12).

The retrieval unit 25 acquires the check point 50 which is newest from the CKPT storage unit 28 and acquires the earliest one among the earliest times 53 from the check point 50. The retrieval unit 25 acquires the event data 30 having the earliest occurrence time 31 among event data 30 created after the earliest time 53 (S13). When the check point 50 is not stored in the CKPT storage unit 28, the retrieval unit 25 acquires the first (earliest) event data 30.

When the occurrence time 31 of the acquired event data 30 is a time before the activation time (Y in S14), the retrieval unit 25 determines the state transition to be performed based on the event data 30 (S15 and S18) and updates the array 60 described below (S16 and S19). The retrieval unit 25 searches the transition table 40 in which the target ID 32 of the event data 30 is included in the range of application 41 by using the type 33 of the event data 30 as a key and determines the state transition (the original state 42 and the new state 43).

When the state is changed to the retrieval state (Y in S15), the retrieval unit 25 acquires the unused array element 61 and stores the target ID 32 (S16).

When the state is changed from the retrieval state to another state (N in S15 and Yin S18), the retrieval unit 25 deletes information of the array element 61 in which stores the target ID 32 that is the same as the target ID 32 of the event data 30 and sets the array element 61 to the unused state (S19). When the state transition is not performed or when the state transition is performed between the other states (N in S15 and S18), the retrieval unit 25 performs nothing.

After the array 60 is updated, the retrieval unit 25 acquires the next event data 30 in order of the occurrence time 31 (S17) and the process returns to the process of S14.

When the occurrence time 31 of the acquired event data 30 is later than the activation time (N in S14), the retrieval unit 25 scans the array 60, acquires all the registered target IDs 32, and outputs them to the user terminal 13 via the input/output unit 23 (S1A).

The data management device 20 of the exemplary embodiment can efficiently retrieve the target (goods or the like) in a state defined in the specific state 52 from the event storage unit 26 which accumulates the event data 30. That is because the retrieval range can be narrowed by holding the check point 50.

The data management device 20 of the exemplary embodiment can efficiently retrieve the target (goods or the like) whose state is any one of a plurality of the states defined in the specific states 52. That is because the check point 50 is held for each state of the states defined in the specific state 52.

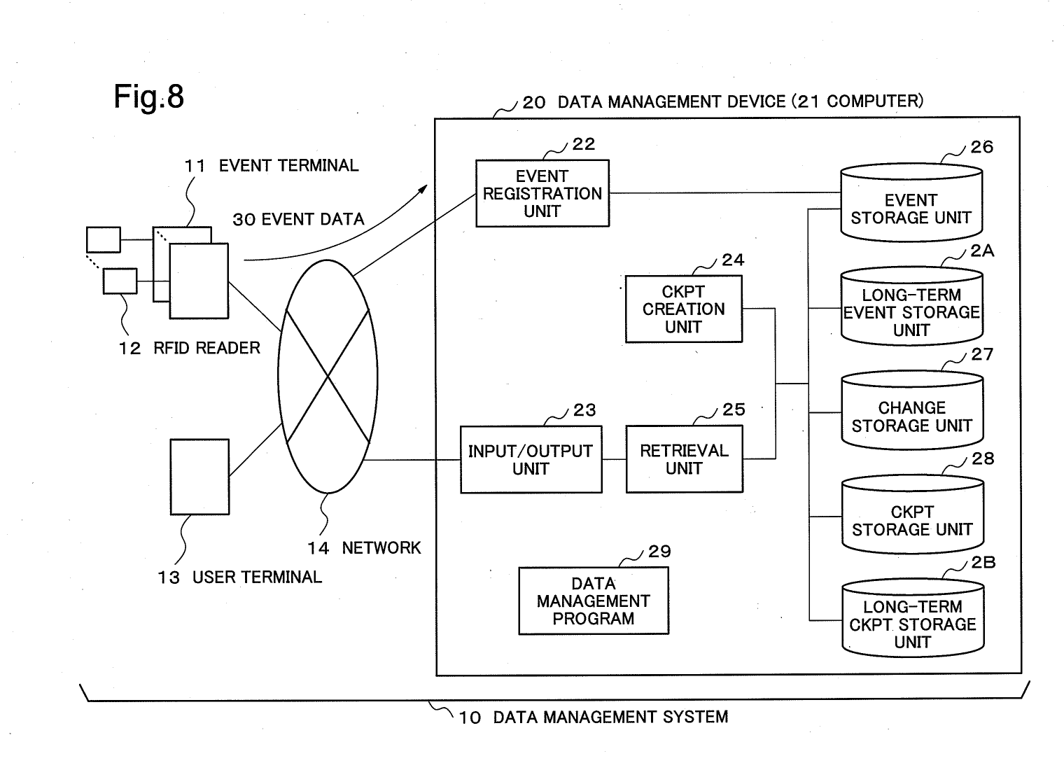

FIG. 8 is an entire configuration diagram of the data management system 10 according to the second exemplary embodiment of the present invention. The data management device 20 of the exemplary embodiment includes a long-term event storage unit 2A and a long-term CKPT storage unit 2B in addition to the configuration of the data management device 20 according to the first exemplary embodiment.

The long-term event storage unit 2A and the long-term CKPT storage unit 2B are storage devices such as disks, memories, and the like. The long-term event storage unit 2A stores a copy (described in detail later) of some of the event data 30 (long-term event data) extracted from the event storage unit 26. The long-term CKPT storage unit 2B stores the check point 50 (long-term check point) created from the long-term event data.

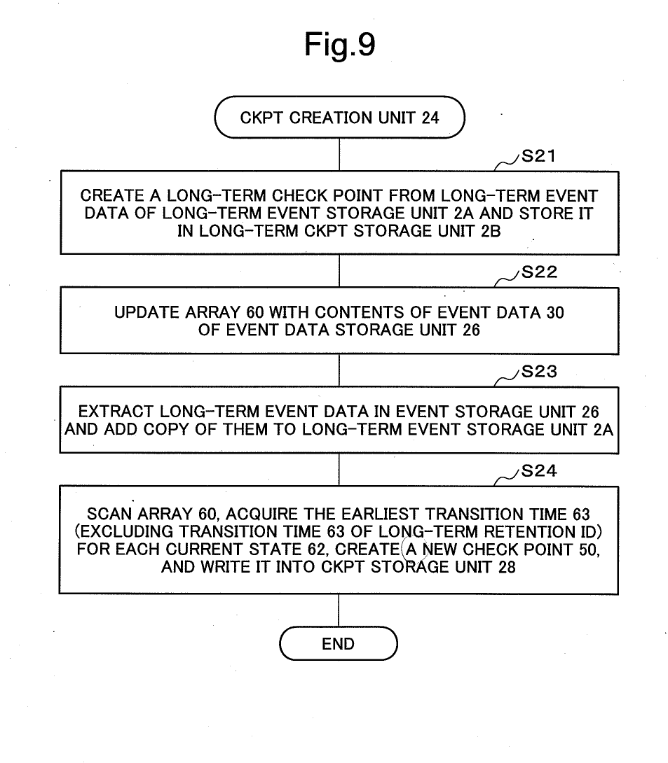

FIG. 9 is an operation flowchart of the CKPT creation unit 24 of the second exemplary embodiment. The CKPT creation unit 24 creates a long-term check point from long-term event data of the long-term event storage unit 2A and stores it in the long-term CKPT storage unit 2B (S21). The detail of this procedure is shown in FIG. 6A and FIG. 6B. However, the event data 30 (long-term event data) is inputted from the long-term event storage unit 2A and not inputted from the event storage unit 26. The check point 50 (long-term check point) is inputted from/outputted to the long-term CKPT storage unit 2B and not inputted from/outputted to the CKPT storage unit 28. At this time, the current state 62 and the transition time 63 of the target ID 32 obtained from the long-term event data are stored in the array 60.

Next, the CKPT creation unit 24 updates the array 60 with contents of the event data 30 of the event data storage unit 26 (S22). The detail of this procedure is shown in S2 to S8 of FIG. 6A and FIG. 6B. After that, the CKPT creation unit 24 extracts long-term event data in the CKPT storage unit 28 and adds a copy of the long-term event data to the long-term CKPT storage unit 2B (S23). At this time, the CKPT creation unit 24 scans the array 60 and acquires the target ID 32 (long-term retention ID) of which a difference between the transition time 63 and the activation time is equal to or greater than a threshold value. The CKPT creation unit 24 determines that the event data 30 including the long-term retention ID as the target ID 32 among the event data 30 of the event storage unit 26 are the long-term event data.

Lastly, the CKPT creation unit 24 scans the array 60, acquires the earliest transition time 63 (excluding the transition time 63 of the long-term retention ID) for each current state 62, creates a new check point 50, and writes it into the CKPT storage unit 28 (S24). The CKPT creation unit 24 stores the activation time, each current state 62, and each earliest transition time 63 in the creation time 51, each specific state 52, and each earliest time 53, respectively. With respect to a state that is defined in the specified list 44 but not registered in the current state 62 of the array 60, the CKPT creation unit 24 stores the activation time in the earliest time 53.

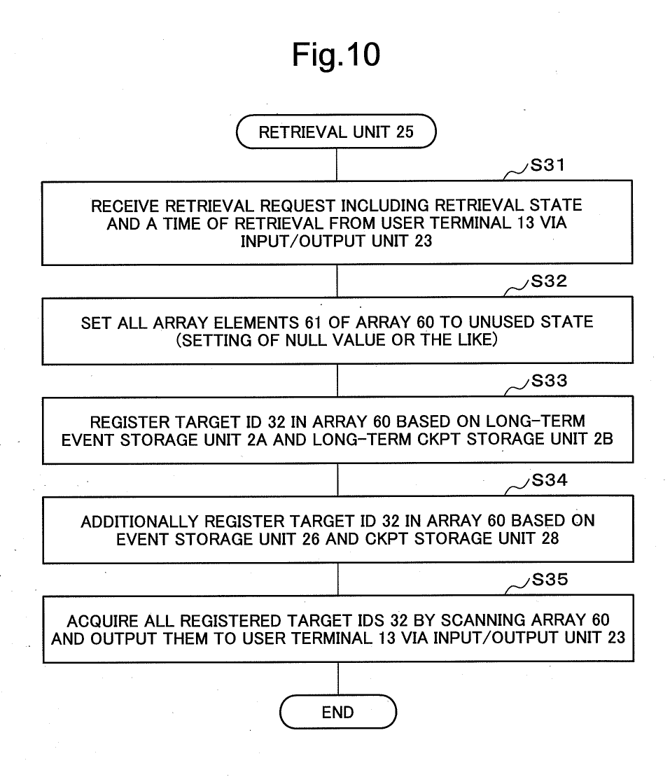

FIG. 10 is an operation flowchart of the retrieval unit 25 of the second exemplary embodiment. The retrieval unit 25 receives a retrieval request including a retrieval state and a time of retrieval from the user terminal 13 via the input/output unit 23 (S31). Next, the retrieval unit 25 sets all the array elements 61 of the array 60 to an unused state (setting of a Null value or the like) (S32).

The retrieval unit 25 registers the target ID 32 in the array 60 based on the long-term event storage unit 2A and the long-term CKPT storage unit 2B (S33). The detailed procedure is shown in S13 to S19 of FIG. 7A and FIG. 7B. The event data 30 (long-term event data) is inputted from the long-term event storage unit 2A and not inputted from the event storage unit 26. The check point 50 (long-term check point) is inputted from/outputted to the long-term CKPT storage unit 2B and not inputted from/outputted to the CKPT storage unit 28.

Next, the retrieval unit 25 additionally registers the target ID 32 in the array 60 based on the event storage unit 26 and the CKPT storage unit 28 (S34). The detailed procedure is shown in S13 to S19 of FIG. 7A and FIG. 7B.

Lastly, the retrieval unit 25 scans the array 60, acquires all the registered target IDs 32, and outputs them to the user terminal 13 via the input/output unit 23 (S35).

The data management system 10 of this exemplary embodiment is the same as that of the first exemplary embodiment except for the above-mentioned point.

The data management device 20 of the exemplary embodiment can efficiently retrieve the target (goods or the like) whose state is any one of a plurality of the states defined in the specific states 52 even in a circumstance in which the target whose state is frequently changed and the target whose state is infrequently changed exist together. That is because the long-term event storage unit 2A, which stores the long-term event data extracted, are provided, the long-term check point is created from the long-term event data, and the check point 50 is created from the event data 30 excluding the long-term event data. Because such configuration is used, the data management device 20 can make the earliest time 53 in the check point 50 close to the creation time 51. Therefore, the retrieval unit 25 can narrow a retrieval range of the event storage unit 26.

The data management devices 20 according to the third exemplary embodiment of the present invention has only one transition table 40 stored in the change storage unit 27 and the transition table 40 does not include a provision range 41 and the specified list 44. Further, when the state transition is simple, the transition information may be included in logic of the CKPT creation unit 24 and the data management device 20 may not include the change storage unit 27. Furthermore, in this exemplary embodiment, a check point 50 (including the long-term check point) only includes one creation time 51 and one earliest time 53.

The data management device 20 of this exemplary embodiment can easily realize an application which has one pattern of the state transition and one type of state that is a retrieval target. That is because a storage capacity of the change storage unit 27 or the like and an amount of processing performed by the CKPT creation unit 24 or the like can be reduced. One example of such application is an inventory management application in logistics.

In the present invention, the data management device 20 may include only the event storage unit 26, the CKPT storage unit 28, and the CKPT creation unit 24. The event registration unit 22, the retrieval unit 25, and the input/output unit 23 may be provided in another device (an event registration device, a retrieval device, or the like) that shares the event storage unit 26 and the CKPT storage unit 28.

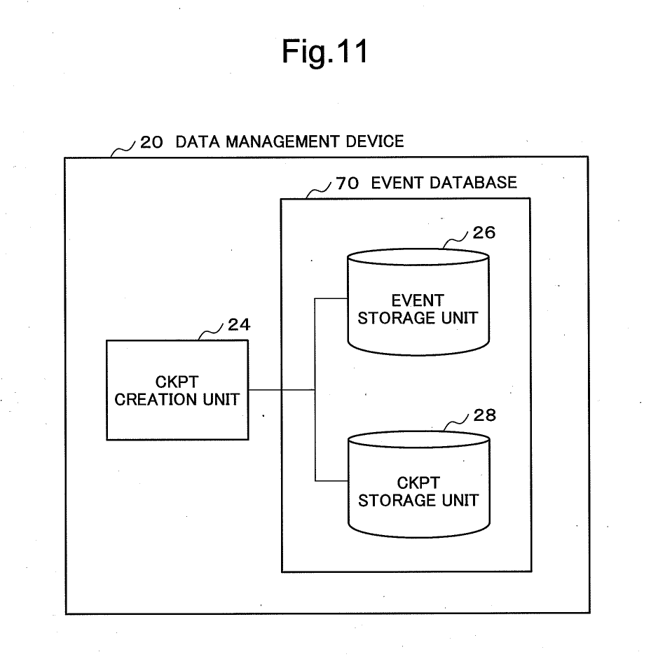

FIG. 11 is a diagram showing a configuration of the data management device 20 of such exemplary embodiment (the fourth exemplary embodiment). Further, an event database 70 includes the event storage unit 26 and the CKPT storage unit 28.

The data management device 20 of this exemplary embodiment can efficiently retrieve the target (goods or the like) in the specific state 52 from the event storage unit 26 which accumulates the event data 30. That is because the retrieval range can be narrowed by holding the check point 50.

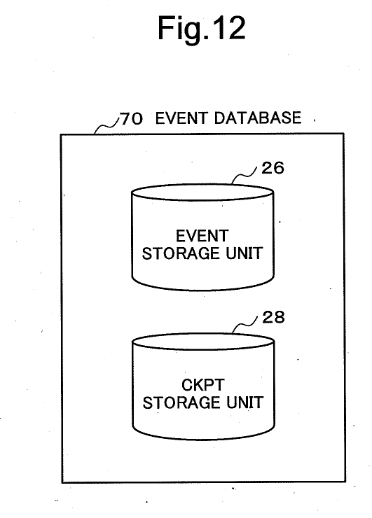

FIG. 12 is a block diagram of the event database 70. For example, when the event storage unit 26 and the CKPT storage unit 28 are portable recording media, the event database 70 can be removed from the data management device 20 having the CKPT creation unit 24. The removed event database 70 may be connected to another device including the CKPT creation unit 24 or the retrieval unit 25. The event database 70 may include the change storage unit 27 or the long-term event storage unit 2A and the long-term CKPT storage unit 2B.

The invention of the present application has been described above with reference to the exemplary embodiment (and the example). However, the invention of the present application is not limited to the above-mentioned exemplary embodiment (and the example). Various changes in the configuration or details of the invention of the present application that can be understood by those skilled in the art can be made without departing from the scope of the invention of the present application.

This application claims priority based on Japanese Patent Application No. 2009-063722 filed on Mar. 17, 2009, and the disclosure of which is hereby incorporated in its entirety.

1-20. (canceled)

21. A data management device comprising:
an event storage unit that stores one or more event data each of which includes an occurrence time of an event which changes a state of a target from a specific state to another state or from another state to the specific state according to a type, the type of the event, and a target ID that is an identifier of the target, the state of which has been changed by the event;
a CKPT storage unit that stores a check point; and
a CKPT creation unit that retrieves an earliest time at a predetermined creation time from the event data in the event storage unit, wherein the earliest time is a time when a target, which was changed to the specific state earliest among targets judged from the event data to be in the specific state at the creation time, was changed to the specific state, creates the check point including the creation time and the earliest time, and stores the check point in the CKPT storage unit.

22. The data management device according to claim 21, further comprising a retrieval unit that extracts the target ID of a target that is in the specific state at a time of retrieval from the event data, in the event storage unit, whose occurrence time is a time after the earliest time included in the check point whose creation time is a time before the time of retrieval, and outputs the extracted target ID.

23. The data management device according to claim 22, wherein
the CKPT unit creates the check point at each of the creation times that come more than once on a regular or irregular basis, from the event data whose occurrence time is a time after the earliest time included in the last created check point, and
the retrieval unit extracts the target ID of the target that is in the specific state at the time of retrieval from the event data whose occurrence time is a time after the earliest time included in the check point which is newest among the check point(s) whose creation time is a time before the time of retrieval.

24. The data management device according to claim 23, further comprising:
a long-term event storage that stores long-term event data, which are event data including the target ID of the target whose state is in the specific state for more than threshold time continuously; and
a long-term CKPT storage unit that stores a long-term check point, wherein
the CKPT creation unit retrieves the earliest time at each of the creation times that come more than once, from the long-term event data, in the long-term event storage unit, whose occurrence time is a time after the earliest time included in the last created long-term check point, creates the long-term check point including the creation time and the earliest time retrieved from the long-term event data, stores the long-term check point in the long-term CKPT storage unit,
extracts the long-term event data from the event data of the event storage unit, stores the long-term event data in the long-term event storage unit, retrieves the earliest time at the creation time from the event data, excluding the long-term event data, in the event storage unit, creates the check point including the creation time and the earliest time retrieved from the event data, and stores the check point in the CKPT storage unit and
the retrieval unit extracts the target ID of the target that is in the specific state at the time of retrieval from the long-time event data, in the long-term event storage unit, whose occurrence time is a time after the earliest time included in the long-term check point which is newest among the long-term check point(s) whose creation time is a time before the time of retrieval and from the event data, in the event storage unit, whose occurrence time is a time after the earliest time included in the check point which is newest among the check point(s) whose creation time is a time before the time of retrieval and outputs the extracted target ID.

25. The data management device according to claim 22, wherein
the CKPT creation unit retrieves the earliest time for each of a plurality of the specific states from the event data in the event storage unit and creates a plurality of the check points including the creation time and each of the earliest times and
the retrieval unit extracts the target ID of the target whose state is a retrieval state that is one of the specific states at the time of retrieval from the event data, in the event storage unit, whose occurrence time is a time after the earliest time of the check point, corresponding to the retrieval state, whose creation time is a time before the time of retrieval and outputs the retrieved target ID.

26. A data management system comprising:
the data management device according to claim 22, which includes an event registration unit that inputs the event data from an event terminal and registers the event data in the event storage unit and the retrieval unit that inputs the time of retrieval from a user terminal and outputs a target ID of a target that is in the specific state at the time of retrieval to the user terminal,
the event terminal, and
the user terminal.

27. An event database comprising:
an event storage unit that stores one or more event data each of which includes an occurrence time of an event which changes a state of a target from a specific state to another state or from another state to the specific state according to a type, the type of the event, and a target ID that is an identifier of the target, the state of which has been changed by the event, and
a CKPT storage unit that stores a check point including an earliest time at a predetermined creation time that is retrieved from the event data in the event storage unit wherein, the earliest time is a time when a target, which was changed to the specific state earliest among targets judged from the event data to be in the specific state at the creation time, was changed to the specific state and the creation time.

28. The event database according to claim 27, wherein the CKPT storage unit stores the check point created for each of the creation times that come more than once on a regular or irregular basis.

29. A non-transient computer-readable recording medium which stores a data management program causing a computer to perform:
an event registration process in which one or more event data each of which includes an occurrence time of an event which changes a state of a target from a specific state to another state or from another state to the specific state according to a type, the type of the event, and a target ID that is an identifier of the target, a state of which has been changed by the event, are stored in an event storing unit, and
a CKPT creation process in which an earliest time at a predetermined creation time is retrieved from the event data in the event storage unit wherein, the earliest time is a time when a target, which was changed to the specific state earliest among targets judged from the event data to be in the specific state at the creation time, was changed to the specific state, a check point including the creation time and the earliest time is created, and the check point is stored in a CKPT storage unit.

30. The non-transient computer-readable recording medium according to claim 29 which stores the data management program causing a computer to perform:
a retrieval process in which the target ID of a target that is in the specific state at a time of retrieval is extracted from the event data, in the event storage unit, whose occurrence time is a time after the earliest time included in the check point whose creation time is a time before the time of retrieval, and is outputted.

31. The non-transient computer-readable recording medium according to claim 30 which stores the data management program causing the computer to perform:
the CKPT process in which the check point is created at each of the creation times that come more than once on a regular or irregular basis, from the event data whose occurrence time is a time after the earliest time included in the last created check point, and
the retrieval process in which the target ID of the target that is in the specific state at the time of retrieval is extracted from the event data whose occurrence time is a time after the earliest time included in the check point which is newest among the check point(s) whose creation time is a time before the time of retrieval.

32. The non-transient computer-readable recording medium according to claim 31 which stores the data management program causing the computer to perform:
the CKPT creation process in which the earliest time at each of the creation times that come more than once, is retrieved from long-term event data, which are event data including the target ID of the target whose state is in the specific state for more than threshold time continuously and are stored in a long-term event storage unit, and whose occurrence time is a time after the earliest time included in a long-term check point which is newest, the long-term check point including the creation time and the earliest time is created and stored in a long-term CKPT storage unit, the long-term event data are extracted from the event data of the event storage unit and stored in the long-term event storage unit, the earliest time at the creation time is retrieved from the event data, excluding the long-term event data, in the event storage unit, the check point including the creation time and the earliest time retrieved from the event data is created and stored in the CKPT storage unit and
a retrieval process in which the target ID of the target that is in the specific state at the time of retrieval is extracted
from the long-term event data, in the long-term event storage unit, whose occurrence time is a time after the earliest time included in the long-term check point which is newest among the long-term check point(s) whose creation time is a time before the time of retrieval and
from the event data, in the event storage unit, whose occurrence time is a time after the earliest time included in the check point which is newest among the check point(s) whose creation time is a time before the time of retrieval, and is outputted.

33. The non-transient computer-readable recording medium according to claim 30 which stores the data management program causing the computer to perform:
the CKPT creation process in which the earliest time is retrieved for each of a plurality of the specific states from the event data in the event storage unit and a plurality of the check points are created including the creation time and each of the earliest times and
the retrieval process in which the target ID of the target whose state is a retrieval state that is one of the specific states at the time of retrieval is extracted from the event data, in the event storage unit, whose occurrence time is a time after the earliest time of the check point, corresponding to the retrieval state, whose creation time is a time before the time of retrieval, and outputted.

34. A data management method comprising:
storing one or more event data each of which includes an occurrence time of an event which changes a state of a target from a specific state to another state or from another state to the specific state according to a type, the type of the event, and a target ID that is an identifier of the target, the state of which has been changed by the event, in an event storing unit, and
retrieving an earliest time at a predetermined creation time from the event data in the event storage unit, wherein the earliest time is a time when the state of the target changed to the specific state earliest among targets judged from the event data to be in the specific state at the creation time, was changed to the specific state, creating a check point including the creation time and the earliest time, and storing the check point in a CKPT storage unit.

35. The data management method according to claim 34 comprising:
extracting the target ID of a target that is in the specific state at a time of retrieval from the event data, in the event storage unit, whose occurrence time is a time after the earliest time included in the check point whose creation time is a time before the time of retrieval and outputting the extracted target ID.

36. The data management method according to claim 35 comprising:
creating the check point at each of the creation times that come more than once on a regular or irregular basis, from the event data whose occurrence time is a time after the earliest time included in the last created check point, and
extracting the target ID of the target that is in the specific state at the time of retrieval from the event data whose occurrence time is a time after the earliest time included in the check point which is newest among the check point(s) whose creation time is a time before the time of retrieval.

37. The data management method according to claim 36 comprising:
retrieving the earliest time at each of the creation times that come more than once, from long-term event data, which are event data including the target ID of the target whose state is in the specific state for more than threshold time continuously and are stored in a long-term event storage unit, and whose occurrence time is a time after the earliest time included in a long-term check point which is newest, creating the long-term check point including the creation time and the earliest time, storing the long-term check point in a long-term CKPT storage unit,
extracting the long-term event data from the event data of the event storage unit, storing the long-term event data in the long-term event storage unit, retrieving the earliest time at the creation time from the event data, excluding the long-term event data, in the event storage unit, creating the check point including the creation time and the earliest time retrieved from the event data, and storing the check point in the CKPT storage unit and
extracting the target ID of the target that is in the specific state at the time of retrieval
from the long-term event data in the long-term event storage unit, whose occurrence time is a time after the earliest time included in the long-term check point which is newest among the long-term check point(s) whose creation time is a time before the time of retrieval and
from the event data, in the event storage unit, whose occurrence time is a time after the earliest time included in the check point which is newest among the check point(s) whose creation time is a time before the time of retrieval and outputting the extracted target ID.

38. The data management method according to claim 35 comprising:
retrieving the earliest time for each of a plurality of the specific states from the event data in the event storage unit and creating a plurality of the check point including the creation time and each of the earliest time; and
extracting the target ID of the target whose state is a retrieval state that is one of the specific states at the time of retrieval from the event data in the event storage unit, whose occurrence time is a time after the earliest time of the check point, corresponding to the retrieval state, whose creation time is a time before the time of retrieval and outputting the retrieved target ID.

39. A data management device comprising:
first means for storing event data including an occurrence time of an event which changes a state of a target from a specific state to another state or from another state to the specific state according to a type, the type of the event, and a target ID that is an identifier of the target, the state of which has been changed by the event;
second means for storing a check point; and
third means for retrieving an earliest time at a predetermined creation time from the event data in the first means, wherein the earliest time is a time when a target, which was changed to the specific state earliest among targets judged from the event data to be in the specific state at the creation time, was changed to the specific state, creating a check point including the creation time and the earliest time, and storing the check point in the second means.

40. An event database comprising:
first means for storing event data including an occurrence time of an event which changes a state of a target from a specific state to another state or from another state to the specific state according to a type, the type of the event, and a target ID that is an identifier of the target, the state of which has been changed by the event, and
second means for storing a check point including
an earliest time at a predetermined creation time that is retrieved from the event data in the first means wherein, the earliest time is a time when a target, which was changed to the specific state earliest among targets judged from the event data to be in the specific state at the creation time, was changed to the specific state and
the creation time.
